(19) United States
(12) Patent Application Publication
(10) Pub. No.: US 2023/0259567 A1
(43) Pub. Date: Aug. 17, 2023

(54) DATA PROCESSING METHOD AND APPARATUS

(71) Applicant: BEIJING SOGOU TECHNOLOGY DEVELOPMENT CO., LTD., Beijing (CN)

(72) Inventors: Jiansu LIN, Beijing (CN); Fang Liu, Beijing (CN); Yuqing Meng, Beijing (CN); Xiaofeng Huang, Beijing (CN); Weipeng Chen, Beijing (CN); Zhaohan Gong, Beijing (CN); Ming Zong, Beijing (CN); Liwei Chen, Beijing (CN); Dandan Wang, Beijing (CN); Yanan Ning, Beijing (CN)

(21) Appl. No.: 18/137,989

(22) Filed: Apr. 21, 2023

Related U.S. Application Data
(63) Continuation of application No. PCT/CN2021/103567, filed on Jun. 30, 2021.

(30) Foreign Application Priority Data
Nov. 2, 2020 (CN) 202011202873.2

(51) Int. Cl. G06F 16/954

(52) U.S. Cl. CPC G06F 16/954

(57) ABSTRACT

This application discloses a data processing method performed by a computing device. The method includes: acquiring a search keyword of a user, and determining a plurality of target keywords related to the search keyword. After the plurality of keywords are determined, the search keyword and the plurality of target keywords may further be displayed. When the search keyword and the plurality of target keywords are displayed, the plurality of target keywords are distributed on a periphery of a circle with the search keyword as a center in a dispersed manner to achieve a more convenient and intuitive effect. By using this solution, the plurality of target keywords related to the search keyword can be displayed for the user instead of directly providing the user with search results corresponding to the search keyword, and the user obtains the plurality of target keywords through analysis according to the search results.

### CROSS-REFERENCE TO RELATED APPLICATIONS

This application is a continuation application of PCT Patent Application No. PCT/CN2021/103567, entitled “DATA PROCESSING METHOD AND APPARATUS” filed on Jun. 30, 2021, which claims priority to Chinese Patent Application No. 202011202873.2, filed with the National Intellectual Property Administration, PRC on Nov. 2, 2020 and entitled “DATA PROCESSING METHOD AND APPARATUS”, all of which are incorporated herein by reference in their entirety.

### FIELD OF THE TECHNOLOGY

This application relates to the field of data processing, and in particular, to a data processing method and apparatus.

### BACKGROUND OF THE DISCLOSURE

With the development of network technologies, users can acquire information they need through the network. For example, a user may enter a search keyword in a search region provided by a search engine and trigger a search operation, and the search engine will provide the user with search results corresponding to the search keyword.

However, search results provided by search engines for the users currently cannot meet the needs of the users, and the user experience is poor.

### SUMMARY

The technical problem to be resolved in this application is that search results provided by search engines for users currently cannot meet the needs of the users, and a data processing method and apparatus are provided.

According to a first aspect, an embodiment of this application provides a data processing method. The method includes:

acquiring a search keyword;

determining a plurality of target keywords related to the search keyword; and

displaying the search keyword and the plurality of target keywords, the plurality of target keywords being distributed on a periphery of a circle with the search keyword as a center in a dispersed manner.

In some embodiments, the displaying the search keyword and the plurality of target keywords includes:

displaying the search keyword and the plurality of target keywords in a form of a compass, the search keyword being located at a center of the compass, and the plurality of target keywords being distributed on a periphery of the compass.

In some embodiments, the plurality of target keywords include a first keyword, and the method further includes:

acquiring a content matching the first keyword and the search keyword; and

displaying a knowledge card corresponding to the first keyword, the knowledge card corresponding to the first keyword including the content matching the first keyword and the search keyword.

In some embodiments, the method further includes:

displaying an association between the first keyword and the search keyword.

In some embodiments, the first keyword is in a selected state.

In some embodiments, the method further includes:

acquiring a second keyword in the plurality of target keywords in response to a target keyword switching operation triggered by a user;

acquiring a content matching the second keyword and the search keyword; and

replacing the knowledge card corresponding to the first keyword with a knowledge card corresponding to the second keyword for display, the knowledge card corresponding to the second keyword including the content matching the second keyword and the search keyword.

In some embodiments, the target keyword switching operation includes:

a click operation or a slide operation.

In some embodiments, the method further includes:

modifying a state of the second keyword to the selected state, and modifying a state of the first keyword to an unselected state.

In some embodiments, the method further includes:

acquiring a content matching a third keyword in the plurality of target keywords and the search keyword in response to a knowledge card switching operation triggered by a user; and

replacing the knowledge card corresponding to the first keyword with a knowledge card corresponding to the third keyword for display, the knowledge card corresponding to the third keyword including the content matching the third keyword and the search keyword.

In some embodiments, the method further includes:

modifying a state of the third keyword to the selected state, and modifying a state of the first keyword to an unselected state.

In some embodiments, the method further includes:

acquiring search results corresponding to the search keyword; and

displaying the search results in a search result display region; and

the displaying the search keyword and the plurality of target keywords includes:

displaying the search keyword and the plurality of target keywords in a content recommendation region.

In some embodiments, the plurality of target keywords include a first keyword, and the method further includes:

acquiring a search result item matching the first keyword in the search results; and

displaying an association between the search result item matching the first keyword in the search results and the first keyword.

In some embodiments, the determining a plurality of target keywords related to the search keyword includes:

determining a plurality of contents related to the search keyword;

determining a keyword corresponding to each of the plurality of contents;

sorting the keywords respectively corresponding to the plurality of contents according to degrees of relevance to the search keyword and/or degrees of popularity of the keywords; and

determining a preset quantity of keywords ranked top as the plurality of target keywords.

In some embodiments, the plurality of contents include a first content, and the determining a keyword corresponding to the first content includes:

determining, when a graph entity library includes the first content, a graph entity corresponding to the first content in the graph entity library as the keyword corresponding to the first content,

the graph entity library including at least a correspondence between a graph entity and a content corresponding to the graph entity.

According to a second aspect, an embodiment of this application provides a data processing apparatus. The apparatus includes:

a first acquisition unit, configured to acquire a search keyword;

a first determining unit, configured to determine a plurality of target keywords related to the search keyword; and

a first display unit, configured to display the search keyword and the plurality of target keywords, the plurality of target keywords being distributed on a periphery of a circle with the search keyword as a center in a dispersed manner.

In some embodiments, the first display unit is configured to:

display the search keyword and the plurality of target keywords in a form of a compass, the search keyword being located at a center of the compass, and the plurality of target keywords being distributed on a periphery of the compass.

In some embodiments, the plurality of target keywords include a first keyword, and the apparatus further includes:

a second acquisition unit, configured to acquire a content matching the first keyword and the search keyword; and

a second display unit, configured to display a knowledge card corresponding to the first keyword, the knowledge card corresponding to the first keyword including the content matching the first keyword and the search keyword.

In some embodiments, the apparatus further includes:

a third display unit, configured to display an association between the first keyword and the search keyword.

In some embodiments, the first keyword is in a selected state.

In some embodiments, the apparatus further includes:

a third acquisition unit, configured to acquire a second keyword in the plurality of target keywords in response to a target keyword switching operation triggered by a user;

a fourth acquisition unit, configured to acquire a content matching the second keyword and the search keyword; and

a fourth display unit, configured to replace the knowledge card corresponding to the first keyword with a knowledge card corresponding to the second keyword for display, the knowledge card corresponding to the second keyword including the content matching the second keyword and the search keyword.

In some embodiments, the target keyword switching operation includes:

a click operation or a slide operation.

In some embodiments, the apparatus further includes:

a first modification unit, configured to modify a state of the second keyword to the selected state, and modify a state of the first keyword to an unselected state.

In some embodiments, the apparatus further includes:

a fifth acquisition unit, configured to acquire a content matching a third keyword in the plurality of target keywords and the search keyword in response to a knowledge card switching operation triggered by a user; and

a fifth display unit, configured to replace the knowledge card corresponding to the first keyword with a knowledge card corresponding to the third keyword for display, the knowledge card corresponding to the third keyword including the content matching the third keyword and the search keyword.

In some embodiments, the apparatus further includes:

a second modification unit, configured to modify a state of the third keyword to the selected state, and modify a state of the first keyword to an unselected state.

In some embodiments, the apparatus further includes:

a sixth acquisition unit, configured to acquire search results corresponding to the search keyword; and

a sixth display unit, configured to display the search results in a search result display region; and

the first display unit is configured to:

display the search keyword and the plurality of target keywords in a content recommendation region.

In some embodiments, the plurality of target keywords include a first keyword, and the apparatus further includes:

a seventh acquisition unit, configured to acquire a search result item matching the first keyword in the search results; and

a seventh display unit, configured to display an association between the search result item matching the first keyword in the search results and the first keyword.

In some embodiments, the first determining unit is configured to:

determine a plurality of contents related to the search keyword;

determine a keyword corresponding to each of the plurality of contents;

sort the keywords respectively corresponding to the plurality of contents according to degrees of relevance to the search keyword and/or degrees of popularity of the keywords; and

determine a preset quantity of keywords ranked top as the plurality of target keywords.

In some embodiments, the plurality of contents include a first content, and the determining a keyword corresponding to the first content includes:

determining, when a graph entity library includes the first content, a graph entity corresponding to the first content in the graph entity library as the keyword corresponding to the first content,

the graph entity library including at least a correspondence between a graph entity and a content corresponding to the graph entity.

According to a third aspect, an embodiment of this application provides a data processing apparatus, including a memory and one or more programs, the one or more programs being stored in the memory and configured to be executed by one or more processors, and the one or more programs including instructions used for performing the following operations:

acquiring a search keyword;

determining a plurality of target keywords related to the search keyword; and

displaying the search keyword and the plurality of target keywords, the plurality of target keywords being distributed on a periphery of a circle with the search keyword as a center in a dispersed manner.

In some embodiments, the displaying the search keyword and the plurality of target keywords includes:

displaying the search keyword and the plurality of target keywords in a form of a compass, the search keyword being located at a center of the compass, and the plurality of target keywords being distributed on a periphery of the compass.

In some embodiments, the plurality of target keywords include a first keyword, and the operations further include:

acquiring a content matching the first keyword and the search keyword; and

displaying a knowledge card corresponding to the first keyword, the knowledge card corresponding to the first keyword including the content matching the first keyword and the search keyword.

In some embodiments, the operations further include:

displaying an association between the first keyword and the search keyword.

In some embodiments, the first keyword is in a selected state.

In some embodiments, the operations further include:

acquiring a second keyword in the plurality of target keywords in response to a target keyword switching operation triggered by a user;

acquiring a content matching the second keyword and the search keyword; and

replacing the knowledge card corresponding to the first keyword with a knowledge card corresponding to the second keyword for display, the knowledge card corresponding to the second keyword including the content matching the second keyword and the search keyword.

In some embodiments, the target keyword switching operation includes:

a click operation or a slide operation.

In some embodiments, the operations further include:

modifying a state of the second keyword to the selected state, and modifying a state of the first keyword to an unselected state.

In some embodiments, the operations further include:

acquiring a content matching a third keyword in the plurality of target keywords and the search keyword in response to a knowledge card switching operation triggered by a user; and

replacing the knowledge card corresponding to the first keyword with a knowledge card corresponding to the third keyword for display, the knowledge card corresponding to the third keyword including the content matching the third keyword and the search keyword.

In some embodiments, the operations further include:

modifying a state of the third keyword to the selected state, and modifying a state of the first keyword to an unselected state.

In some embodiments, the operations further include:

acquiring search results corresponding to the search keyword; and

displaying the search results in a search result display region; and

the displaying the search keyword and the plurality of target keywords includes:

displaying the search keyword and the plurality of target keywords in a content recommendation region.

In some embodiments, the plurality of target keywords include a first keyword, and the operations further include:

acquiring a search result item matching the first keyword in the search results; and

displaying an association between the search result item matching the first keyword in the search results and the first keyword.

In some embodiments, the determining a plurality of target keywords related to the search keyword includes:

determining a plurality of contents related to the search keyword;

determining a keyword corresponding to each of the plurality of contents;

sorting the keywords respectively corresponding to the plurality of contents according to degrees of relevance to the search keyword and/or degrees of popularity of the keywords; and

determining a preset quantity of keywords ranked top as the plurality of target keywords.

In some embodiments, the plurality of contents include a first content, and the determining a keyword corresponding to the first content includes:

determining, when a graph entity library includes the first content, a graph entity corresponding to the first content in the graph entity library as the keyword corresponding to the first content,

the graph entity library including at least a correspondence between a graph entity and a content corresponding to the graph entity.

According to a fourth aspect, an embodiment of this application provides a non-transitory computer-readable medium, storing instructions, the instructions, when executed by one or more processors, causing an apparatus to perform the method according to any one of the first aspect.

Compared with the existing technologies, the embodiments of this application have the following advantages:

The embodiments of this application provide a data processing method. The method includes: acquiring a search keyword of a user, and determining a plurality of target keywords related to the search keyword after the search keyword is acquired. The target keywords may be keywords with a relatively high degree of matching with the search keyword. After the plurality of keywords are determined, the search keyword and the plurality of target keywords may further be displayed. When the search keyword and the plurality of target keywords are displayed, to achieve a more convenient and intuitive effect, the plurality of target keywords are distributed on a periphery of a circle with the search keyword as a center in a dispersed manner. As can be seen from this, by using this solution, after the user enters the search keyword, the plurality of target keywords related to the search keyword can be displayed for the user instead of directly providing the user with search results corresponding to the search keyword as in the conventional technology, and the user obtains the plurality of target keywords through analysis according to the search results. Therefore, by using the method in the embodiments of this application, target keywords meeting needs of the user can be provided to the user according to the search keyword, thereby improving user experience.

### BRIEF DESCRIPTION OF THE DRAWINGS

To describe the technical solutions in the embodiments of this application or the existing technologies more clearly, the following briefly describes the accompanying drawings required for describing the embodiments or the existing technologies. Apparently, the accompanying drawings in the following description show only some of the embodiments of this application, and a person of ordinary skill in the art may derive other drawings from the accompanying drawings without creative efforts.

FIG. 1 is a schematic flowchart of a data processing method according to an embodiment of this application.

FIG. 2 is a schematic structural diagram of a data processing apparatus according to an embodiment of this application.

FIG. 3 is a schematic structural diagram of a client according to an embodiment of this application.

FIG. 4 is a schematic structural diagram of a server according to an embodiment of this application.

### DESCRIPTION OF EMBODIMENTS

To make a person skilled in the art understand solutions of this application better, the following clearly and completely describes the technical solutions in the embodiments of this application with reference to the accompanying drawings in the embodiments of this application. Apparently, the described embodiments are merely some but not all of the embodiments of this application. All other embodiments obtained by a person of ordinary skill in the art based on the embodiments of this application without creative efforts shall fall within the protection scope of this application.

The inventor of this application found through research that, search results provided by a search engine for a user according to a search keyword currently cannot meet the needs of the user. Specifically, most of the search results provided by the search engine for the user are hyperlinks to contents related to the search keyword. In some scenarios, the user needs to first read the contents corresponding to the hyperlinks, and then analyze the contents, so as to summarize the cores of the contents, or summarize keywords corresponding to the contents. For example, when the user enters a search keyword “Laoganma” in a search region of the search engine, the search engine provides the user with several search results. The search results may include, for example, several hyperlinks of news related to Laoganma. The user needs to read the news and analyze and summarize the news. For example, one piece of news is analyzed and it is determined that the core thereof is “Tao Bihua”. In another example, another piece of news is analyzed and it is determined that the core thereof is “Not listed”. In still another example, another piece of news is analyzed and it is determined that the core thereof is “Tencent”.

To resolve the problem described above, the embodiments of this application provide a data processing method, in which target keywords meeting needs of the user can be provided to the user according to the search keyword, thereby improving user experience.

Various non-limiting implementations of this application are described below in detail with reference to the accompanying drawings.

Exemplary Methods

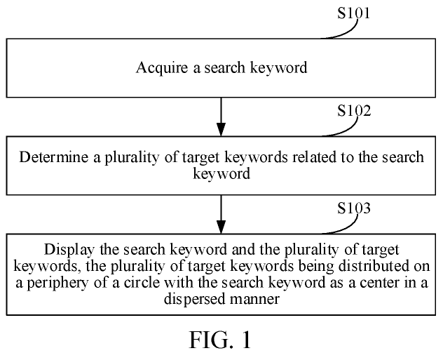

FIG. 1 is a schematic flowchart of a data processing method according to an embodiment of this application.

The data processing method provided in this embodiment of this application may be performed by a controller or processor having a data processing function, or may be performed by a device including the controller or processor, which is not specifically limited in this embodiment of this application. The device including the controller or processor includes, but not limited to, a terminal device and a server.

The method provided in this embodiment of this application may be applied to a mobile terminal search scenario or a personal computer (PC) search scenario, which is not specifically limited in this embodiment of this application.

In this embodiment, the method may include, for example, the following steps S101 to S103.

S101: Acquire a search keyword.

In this embodiment of this application, the search keyword may include one or more characters. The characters mentioned herein include, but not limited to, Chinese characters, English characters, Korean characters, French characters, and the like.

For example, the search keyword may be entered by a user. For example, the search keyword may be entered by the user in an input region provided by a search engine. In still another example, the search keyword may be learned according to historical search records or historical browsing records of the user.

S102: Determine a plurality of target keywords related to the search keyword.

S103: Display or cause a display of the search keyword and the plurality of target keywords, the plurality of target keywords being distributed on a periphery of a circle with the search keyword as a center in a dispersed manner.

Considering that if the user is directly provided with hyperlinks to contents related to the search keyword, the user further needs to analyze and summarize the contents to obtain keywords corresponding to the contents. To improve user experience, in this embodiment of this application, after the search keyword is acquired, a plurality of target keywords related to the search keyword may be determined, and the search keyword and the plurality of target keywords may be displayed. In this way, the user can directly know the target keywords corresponding to the search keyword according to the display results without analyzing the contents corresponding to the search keyword to obtain the plurality of target keywords. As can be seen from this, by using the solution in the embodiments of this application, target keywords meeting needs of the user can be provided to the user according to the search keyword, thereby improving user experience.

The plurality of target keywords are keywords with a relatively high degree of matching with the search keyword. The degree of matching mentioned herein may be an association in contents or an association between characters, which is not specifically limited in this embodiment of this application.

The association in contents may be reflected as that, for example, two keywords appear in the same article or news. For example, for a keyword “Laoganma” and a keyword “Tencent”, “Laoganma” and “Tencent” simultaneously appear in some articles or news, and if “Laoganma” is used as a search keyword, its corresponding target keywords may include “Tencent”.

The association between characters may be reflected as, for example, a natural association between two keywords. For example, for a keyword “doctor” and a keyword “hospital”, there is a specific natural association between the two keywords, and if “hospital” is used as a search keyword, its corresponding target keywords may include “doctor”.

In an implementation of this embodiment of this application, during specific implementation of S102, the search engine may first determine a plurality of contents related to the search keyword. After the plurality of contents related to the search keyword are determined, keywords respectively corresponding to the plurality of contents may be determined, to obtain a plurality of keywords. Subsequently, the plurality of target keywords are determined from the plurality of keywords. The plurality of contents related to the search keyword mentioned herein may be, for example, a plurality of web pages related to the search keyword.

For ease of description, “any one of the plurality of contents related to the search keyword” is referred to as a first content. Subsequently, specific implementation of determining a keyword corresponding to the first content is described.

In an implementation of this embodiment of this application, a graph entity library may be pre-constructed, and the keyword corresponding to the first content may be determined with reference to the graph entity library. The graph entity library may include a correspondence between a graph entity and a content corresponding to the graph entity. The content corresponding to the graph entity may include, for example, text, a picture, and a web page corresponding to the graph entity. Specifically,

when the keyword corresponding to the first content is determined, whether the graph entity library includes the first content may be determined. When a graph entity library includes the first content, a graph entity corresponding to the first content in the graph entity library may be determined as the keyword corresponding to the first content. It may be understood that, for this case, the graph entity library includes a correspondence between the first content and the keyword corresponding to the first content. When the graph entity library does not include the first content, the keyword corresponding to the first content cannot be determined based on the graph entity library. For this case, in this embodiment of this application, semantic analysis may be performed on the first content, to obtain the keyword corresponding to the first content. Specific implementation of performing semantic analysis on the first content is not described in detail herein.

Considering that in some embodiments, the user generally pays more attention to hot topics. Therefore, during specific implementation of determining the plurality of target keywords from the plurality of keywords, for example, the plurality of keywords may be sorted according to a degree of popularity of each keyword and/or a degree of relevance between the keyword and the search keyword, and a preset quantity of keywords ranked top are determined as the plurality of target keywords. The preset quantity of keywords ranked top are keywords with a relatively high degree of popularity and/or a relatively high degree of relevance to the search keyword. In this manner, the obtained target keywords have a relatively high degree of popularity and/or a relatively high degree of relevance to the search keyword. The degree of popularity of the keyword may be determined by the degree of popularity of the content corresponding to the keyword in the contents related to the search keyword. The degree of popularity of a content may be determined according to a browsing frequency of the content by network users, which is not specifically limited in this embodiment of this application.

An example is now used for illustration of the foregoing description part for S102.

The user enters the search keyword “Laoganma”, and the search engine obtains 100 web pages through search. Keywords corresponding to the 100 web pages are respectively determined, and 20 keywords are obtained (because keywords corresponding to different web pages may be the same). Degrees of popularity of the 20 keywords are respectively determined. Subsequently, the 20 keywords are sorted according to the degrees of popularity of the 20 keywords and/or the degrees of relevance between the 20 keywords and the search keyword, and the top 10 keywords are determined as target keywords. It is assumed that among the 100 web pages, keywords corresponding to four web pages are all a keyword A, then a degree of popularity of the keyword A may be determined according to degrees of popularity of the four web pages.

In this embodiment of this application, during specific implementation of S103, in order to that a more intuitive effect can be achieved, and the user can intuitively determine the target keywords corresponding to the search keyword, in this embodiment of this application, the plurality of target keywords are distributed on a periphery of a circle with the search keyword as a center in a dispersed manner.

The “with the search keyword as a center” refers to using a display position of the search keyword as a center. The plurality of target keywords may be evenly distributed on the periphery of the circle with the search keyword as a center, or unevenly distributed on the periphery of the circle with the search keyword as a center, which is not specifically described in this embodiment of this application.

It may be understood that a plurality of concentric circles can be constructed with the search keyword as a center. Radii corresponding to the circles may be different, and the radii corresponding to the circles may alternatively be the same. If the radii corresponding to the circles are the same, the circles are located on a spherical surface with the search keyword as a center.

In an implementation of this embodiment of this application, the plurality of target keywords may be distributed on a periphery of a circle with the search keyword as a center in a dispersed manner.

In still another implementation of this embodiment of this application, the plurality of target keywords may be divided into several groups. One group includes one or more target keywords, and one group of target keywords are correspondingly distributed on a periphery of one circle with the search keyword as a center. For example: in S102, 10 target keywords related to the search keyword are determined, and the 10 target keywords are divided into two groups, where each group includes five target keywords. The five target keywords included in the first group of target keywords are distributed on a periphery of a circle with the search keyword as a center and r1 as a radius in a dispersed manner; and the five target keywords included in the second group of target keywords are distributed on a periphery of a circle with the search keyword as a center and r2 as a radius in a dispersed manner, where r1 and r2 are not equal. In another example: in S102, 10 target keywords related to the search keyword are determined, and the 10 target keywords are divided into two groups, where each group includes five target keywords. The five target keywords included in the first group of target keywords are distributed on a periphery of a circle with the search keyword as a center and r1 as a radius in a dispersed manner; and the five target keywords included in the second group of target keywords are distributed on a periphery of another circle with the search keyword as a center and r1 as a radius in a dispersed manner. It may be understood that in this manner, the 10 target keywords are actually displayed on a spherical surface with the search keyword as a center in a dispersed manner, thereby having the effect of 3D display.

In an implementation of S103, the search keyword and the plurality of target keywords may be displayed in a form of a compass. During display in the form of a compass, a compass may be displayed, the search keyword is located at a center of the compass, and the plurality of target keywords are distributed on a periphery of the compass. For example, the search keyword is “Laoganma”, which corresponds to four target keywords: “Tencent”, “Not listed”, “Tao Bihua”, and “Hot sauce”. During display in the form of a compass, “Laoganma” is located in the center of the compass, and “Tencent”, “Not listed”, “Tao Bihua”, and “Hot sauce” are distributed on the periphery of the compass in a dispersed manner.

In some embodiments, the plurality of target keywords may include a first keyword. Considering that in addition to intending to know the target keywords corresponding to the search keyword, the user further intends to know a specific content matching the first keyword and the search keyword. Therefore, in an implementation of this embodiment of this application, in addition to display of the plurality of target keywords and the search keyword, the content matching the first keyword and the search keyword may further be acquired, and a knowledge card corresponding to the first keyword is displayed, the knowledge card corresponding to the first keyword includes the foregoing content matching the first keyword and the search keyword. For example, if the search keyword is “Laoganma”, and the first keyword is “Tao Bihua”, the knowledge card of the first keyword may be, for example, related information of Tao Bihua creating Laoganma.

In an implementation of this embodiment of this application, during specific implementation of acquiring a content matching the first keyword and the search keyword, for example, the search keyword and the first keyword may be used as retrieval keywords to acquire the content matching the first keyword and the search keyword.

In still another implementation of this embodiment of this application, during specific implementation, the acquiring a content matching the first keyword and the search keyword may be, for example, acquiring a content of which the corresponding keyword is the first keyword in the contents corresponding to the search keyword mentioned in S102. In an implementation, the knowledge card corresponding to the first keyword may be displayed above the first keyword. For example, when the search keyword and the plurality of target keywords are displayed in the form of a compass, the knowledge card corresponding to the first keyword may be located above the compass. In another implementation, the knowledge card corresponding to the first keyword may be displayed below the first keyword. For example, when the search keyword and the plurality of target keywords are displayed in the form of a compass, the knowledge card corresponding to the first keyword may be located below the compass. Certainly, the knowledge card corresponding to the first keyword may alternatively be displayed on the left or right side of the first keyword, which is not specifically limited in this embodiment of this application.

In an implementation, considering that there may be a relatively large quantity of target keywords determined in S102, if the foregoing operation of displaying the knowledge card corresponding to the first keyword performed for the first keyword is performed for each target keyword, there will be a relatively large quantity of displayed knowledge cards, which brings some interference to the user. To avoid this problem, in this embodiment of this application, after the search keyword and the plurality of target keywords are displayed, a state of the first keyword may be determined as a selected state. In other words, only for a target keyword in the selected state, the foregoing operation of displaying the knowledge card corresponding to the target keyword is performed.

For the first keyword in the selected state, a target keyword with the highest degree of relevance to the search keyword in the plurality of target keywords may be determined as the first keyword; or a target keyword with the highest degree of popularity in the plurality of target keywords may be determined as the first keyword; or a target keyword may be randomly selected from the plurality of target keywords as the first keyword, which is not specifically limited in this embodiment of this application.

For example, to help the user distinguish between target keywords in the selected state and target keywords in an unselected state, a display manner of the target keywords in the selected state may be different from that of the target keywords in the unselected state. For example, target keywords in the selected state are displayed in a first font, while target keywords in the unselected state are displayed in a second font. In another example, during display of the plurality of target keywords, other marks are added to the target keywords in the selected state.

To help the user determine the association between the first keyword and the search keyword, for example, the association between the first keyword and the search keyword may further be displayed. For example, the association between the first keyword and the search keyword may be displayed on a connection line between the search keyword and the first keyword. In another example, the association between the first keyword and the search keyword may be displayed in another display region, for example, above the first keyword. For example: the search keyword is “Laoganma”, and the first keyword is “Tao Bihua”, then “Founder” or “Legal representative” may be displayed on a connection line between “Laoganma” and “Tao Bihua”.

In some embodiments, in addition to including the first keyword, the plurality of target keywords may further include a second keyword. In some scenarios, considering that the user may intend to know a content related to the second keyword and the search keyword, in this case, when a currently displayed content includes the knowledge card corresponding to the first keyword, the user may further trigger a target keyword switching operation to switch the target keyword in the selected state from the first keyword to the second keyword. After the target keyword in the selected state is switched to the second keyword, the content matching the second keyword and the search keyword may further be acquired, and the knowledge card corresponding to the first keyword may be replaced with a knowledge card corresponding to the second keyword for display. The knowledge card corresponding to the second keyword includes the content matching the second keyword and the search keyword.

As described above, in some embodiments, only for a target keyword in the selected state, a knowledge card corresponding to the target keyword is displayed. Therefore, in this embodiment of this application, after the knowledge card corresponding to the first keyword is replaced with the knowledge card corresponding to the second keyword for display, a state of the second keyword may further be modified from the unselected state to the selected state, and a state of the first keyword may further be modified from the selected state to the unselected state.

In an implementation of this embodiment of this application, during specific implementation of acquiring a content matching the second keyword and the search keyword, for example, the search keyword and the second keyword may be used as retrieval keywords to acquire the content matching the second keyword and the search keyword.

In still another implementation of this embodiment of this application, during specific implementation, the acquiring a content matching the second keyword and the search keyword may be, for example, acquiring a content of which the corresponding keyword is the second keyword in the contents corresponding to the search keyword mentioned in S102.

In this embodiment of this application, the user may realize switching between target keywords by performing a preset operation. For example, the user may click on a region at which the search keyword is located, to trigger a target keyword switching operation. In still another example, the user may perform a slide operation on a display region at which the search keyword and the plurality of target keywords are located, to trigger a target keyword switching operation.

An example in which the search keyword and the plurality of target keywords are displayed in the form of a compass is used for illustration. For example: the user may click on the center of the compass, to trigger the compass to rotate in a specific direction (for example, clockwise). The user performs one click, and the target keyword in the selected state is switched in sequence to the adjacent target keyword in the clockwise direction. In another example: the user may perform a right-slide operation on the compass to trigger the compass to rotate clockwise. The user triggers one right-slide operation, and the target keyword in the selected state is switched in sequence to the adjacent target keyword in the clockwise direction. In another example: the user may perform a left-slide operation on the compass to trigger the compass to rotate counterclockwise. The user triggers one left-slide operation, and the target keyword in the selected state is switched in sequence to the adjacent target keyword in the counterclockwise direction.

For example, if the user performs several target keyword switching operations and switches the target keyword in the selected state to the last target keyword, when the user performs a target keyword switching operation again, the target keyword in the selected state is switched to the first target keyword. For example, there are five target keywords in total. After S103 is performed, the first target keyword is in the selected state, and then the user sequentially clicks on the center of the compass to perform four target keyword switching operations. After the user performs the target keyword switching operation for the fourth time, the fifth target keyword is in the selected state. Subsequently, if the user clicks on the center of the compass again to perform a target keyword switching operation, the first target keyword will be in the selected state.

As described above, in some embodiments, in addition to including the first keyword, the plurality of target keywords may further include a third keyword. In some scenarios, considering that the user may intend to know a content related to the third keyword and the search keyword, for this case, when a currently displayed content includes the knowledge card corresponding to the first keyword, the user may further trigger a knowledge card switching operation. After the user triggers the knowledge card switching operation, the device performing the data processing method provided in this embodiment of this application may acquire a content matching the third keyword and the search keyword, and replace the knowledge card corresponding to the first keyword with a knowledge card corresponding to the third keyword for display, the knowledge card corresponding to the third keyword including the content matching the third keyword and the search keyword.

In an implementation of this embodiment of this application, during specific implementation of acquiring a content matching the third keyword and the search keyword, for example, the search keyword and the third keyword may be used as retrieval keywords to acquire the content matching the third keyword and the search keyword.

In still another implementation of this embodiment of this application, during specific implementation, the acquiring a content matching the third keyword and the search keyword may be, for example, acquiring a content of which the corresponding keyword is the third keyword in the contents corresponding to the search keyword mentioned in S102.

In this embodiment of this application, the user may realize switching between knowledge cards by performing a preset operation. For example, a control configured to trigger a knowledge card switching operation may be included in a display region of the knowledge card of the first keyword, and the user may use the control to trigger the knowledge card switching operation. For example, the user may click the control to trigger a knowledge card switching operation.

As described above, in some embodiments, only for a target keyword in the selected state, a knowledge card corresponding to the target keyword is displayed. Therefore, in this embodiment of this application, after the knowledge card corresponding to the first keyword is replaced with the knowledge card corresponding to the third keyword for display, a state of the third keyword may further be modified from the unselected state to the selected state, and a state of the first keyword may further be modified from the selected state to the unselected state.

The third keyword mentioned herein and the foregoing second keyword may be the same target keyword, or may be two different target keywords, which is not specifically limited in this embodiment of this application.

To provide users with more contents related to the search keyword, for example, after the search keyword is acquired, in addition to execution of S102 and S103, search results corresponding to the search keyword may further be acquired, and the search results may further be displayed in a search result display region. The search results corresponding to the search keyword may include, for example, several hyperlinks to the contents related to the search keyword. For this case, during specific implementation of S103, for example, the search keyword and the plurality of target keywords may be displayed in a content recommendation region. For the search result display region and the content recommendation region, in a search scenario, a device display region may include an input region and a display region, and the display region may be divided into the search result display region and the content recommendation region. For example, the display region may be divided into two regions, where the left region is the search result display region, and the right region is the content recommendation region.

For specific implementation of acquiring search results corresponding to the search keyword, this is not specifically limited in this embodiment of this application. For example, the search keyword may be used as a retrieval keyword to acquire search results corresponding to the search keyword.

In addition, if the search results corresponding to the search keyword and the search keyword and the plurality of target keywords are simultaneously displayed, to facilitate the user determine the association between the search results and the target keywords, for the first keyword, a search result item matching the first keyword in the search results may further be acquired, and an association between the search result item matching the first keyword in the search results and the first keyword is displayed.

During specific implementation of acquiring the search result item matching the first keyword in the search results, for example, a degree of relevance between the first keyword and each search result item in the search results may be calculated, and if the degree of relevance is higher than a specific threshold, it is determined that the search result item is a search result item matching the first keyword.

During specific implementation of displaying the association between the search result item matching the first keyword in the search results and the first keyword, for example, a connection line may be added between the search result item matching the first keyword in the search results and the first keyword and displayed. For example: the search keyword is “Laoganma”, the search results include 10 search result items (that is, 10 hyperlinks related to Laoganma), and the first keyword is “Tencent”, where both the first search result item and the third search result item are related to the oolong contract event between Laoganma and Tencent. That is, both the first search result item and the third search result item match the first keyword “Tencent”. Therefore, a connection line may be added between the first search result item and the first keyword “Tencent” and displayed. Correspondingly, a connection line may be added between the third search result item and the first keyword “Tencent” and displayed.

As described above, considering that there may be a relatively large quantity of target keywords determined in S102, if the foregoing operation of displaying the association between the search result item matching the first keyword in the search results and the first keyword is performed for each target keyword, there will be a relatively large quantity of displayed “associations” (for example, connection lines), which brings some interference to the user. To avoid this problem, in this embodiment of this application, only for a target keyword in the selected state, the foregoing step of the operation of displaying an association between the search result item matching the target keyword in the search results and the target keyword is performed.

Exemplary Devices

Based on the method provided in the foregoing embodiments, the embodiments of this application further provide an apparatus. The apparatus is described below with reference to the accompanying drawings.

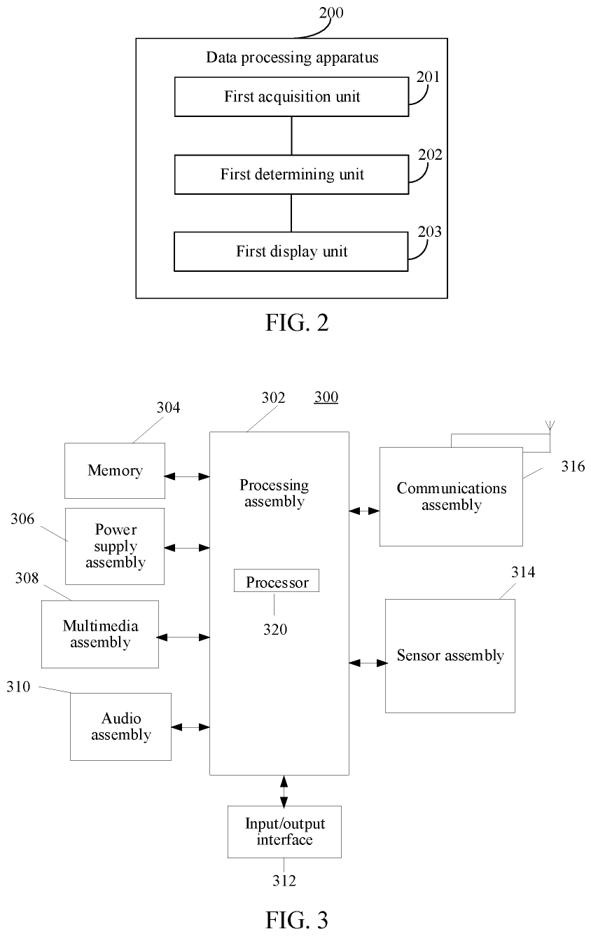

FIG. 2 is a schematic structural diagram of a data processing apparatus according to an embodiment of this application. The apparatus 200 may specifically include, for example, a first acquisition unit 201, a first determining unit 202, and a first display unit 203.

The first acquisition unit 201 is configured to acquire a search keyword;

the first determining unit 202 is configured to determine a plurality of target keywords related to the search keyword; and

the first display unit 203 is configured to display the search keyword and the plurality of target keywords, the plurality of target keywords being distributed on a periphery of a circle with the search keyword as a center in a dispersed manner.

In an implementation, the first display unit 203 is configured to:

display the search keyword and the plurality of target keywords in a form of a compass, the search keyword being located at a center of the compass, and the plurality of target keywords being distributed on a periphery of the compass.

In an implementation, the plurality of target keywords include a first keyword, and the apparatus further includes:

a second acquisition unit, configured to acquire a content matching the first keyword and the search keyword; and

a second display unit, configured to display a knowledge card corresponding to the first keyword, the knowledge card corresponding to the first keyword including the content matching the first keyword and the search keyword.

In an implementation, the apparatus further includes:

a third display unit, configured to display an association between the first keyword and the search keyword.

In an implementation, the first keyword is in a selected state.

In an implementation, the apparatus further includes:

a third acquisition unit, configured to acquire a second keyword in the plurality of target keywords in response to a target keyword switching operation triggered by a user;

a fourth acquisition unit, configured to acquire a content matching the second keyword and the search keyword; and

a fourth display unit, configured to replace the knowledge card corresponding to the first keyword with a knowledge card corresponding to the second keyword for display, the knowledge card corresponding to the second keyword including the content matching the second keyword and the search keyword.

In an implementation, the target keyword switching operation includes:

a click operation or a slide operation.

In an implementation, the apparatus further includes:

a first modification unit, configured to modify a state of the second keyword to the selected state, and modify a state of the first keyword to an unselected state.

In an implementation, the apparatus further includes:

a fifth acquisition unit, configured to acquire a content matching a third keyword in the plurality of target keywords and the search keyword in response to a knowledge card switching operation triggered by a user; and

a fifth display unit, configured to replace the knowledge card corresponding to the first keyword with a knowledge card corresponding to the third keyword for display, the knowledge card corresponding to the third keyword including the content matching the third keyword and the search keyword.

In an implementation, the apparatus further includes:

a second modification unit, configured to modify a state of the third keyword to the selected state, and modify a state of the first keyword to an unselected state.

In an implementation, the apparatus further includes:

a sixth acquisition unit, configured to acquire search results corresponding to the search keyword; and

a sixth display unit, configured to display the search results in a search result display region; and

the first display unit 203 is configured to:

display the search keyword and the plurality of target keywords in a content recommendation region.

In an implementation, the plurality of target keywords include a first keyword, and the apparatus further includes:

a seventh acquisition unit, configured to acquire a search result item matching the first keyword in the search results; and

a seventh display unit, configured to display an association between the search result item matching the first keyword in the search results and the first keyword.

In an implementation, the first determining unit is configured to:

determine a plurality of contents related to the search keyword;

determine a keyword corresponding to each of the plurality of contents;

sort the keywords respectively corresponding to the plurality of contents according to degrees of relevance to the search keyword and/or degrees of popularity of the keywords; and

determine a preset quantity of keywords ranked top as the plurality of target keywords.

In an implementation, the plurality of contents include a first content, and the determining a keyword corresponding to the first content includes:

determining, when a graph entity library includes the first content, a graph entity corresponding to the first content in the graph entity library as the keyword corresponding to the first content,

the graph entity library including at least a correspondence between a graph entity and a content corresponding to the graph entity.

Because the apparatus 200 is an apparatus corresponding to the method provided in the foregoing method embodiments, the specific implementation of each unit of the apparatus 200 is based on the same idea as the foregoing method embodiments. Therefore, for the specific implementation of each unit of the apparatus 200, reference may be made to the description part of the foregoing method embodiments, and details are not described herein again.

The method provided in the embodiments of this application may be performed by a client or a server, and the client and the server that performs the foregoing method are described separately below.

FIG. 3 is a block diagram of a client 300. For example, the client 300 may be a mobile phone, a computer, a digital broadcasting terminal, a message transceiver, a game console, a tablet device, a medical device, a fitness facility, a personal digital assistant, or the like.

Referring to FIG. 3, the client 300 may include one or more of the following components: a processing assembly 302, a memory 304, a power supply assembly 306, a multimedia assembly 308, an audio assembly 310, an input/output (I/O) interface 33, a sensor assembly 314, and a communications assembly 316.

The processing assembly 302 generally controls integral operations of the client 300, such as operations associated with displaying, a phone call, data communication, a camera operation, and a record operation. The processing assembly 302 may include one or more processors 320 to execute instructions, to implement all or some steps of the foregoing method. In addition, the processing assembly 302 may include one or more modules, to facilitate the interaction between the processing assembly 302 and other assemblies. For example, the processing assembly 302 may include a multimedia module, to facilitate the interaction between the multimedia assembly 308 and the processing assembly 302.

The memory 304 is configured to store data of various types to support operations on the client 300. Examples of the data include instructions of any application or method that are used for operations on the client 300, such as contact data, address book data, a message, a picture, and a video. The memory 304 can be implemented by any type of volatile or non-volatile storage devices or a combination thereof, such as a static random access memory (SRAM), an electrically erasable programmable read-only memory (EPROM), a programmable read-only memory (PROM), a read-only memory (ROM), a magnetic memory, a flash memory, a magnetic disc, or an optical disc.

The power supply assembly 306 provides power to various components of the client 300. The power supply assembly 306 may include a power supply management system, one or more power supplies, and other components associated with generating, managing and allocating power for the client 300.

The multimedia assembly 308 includes a screen providing an output interface between the client 300 and a user. In some embodiments, the screen may include a liquid crystal display (LCD) and a touch panel (TP). If the screen includes a TP, the screen may be implemented as a touchscreen, to receive an input signal from the user. The TP includes one or more touch sensors to sense touching, sliding, and gestures on the TP. The touch sensor may not only sense the boundary of touching or slide operations, but also detect duration and pressure related to the touching or slide operations. In some embodiments, the multimedia assembly 308 includes a front camera and/or a rear camera. When the client 300 is in an operating mode, such as a shooting mode or a video mode, the front-facing camera and/or the rear-facing camera may receive external multimedia data. Each front camera and rear camera may be a fixed optical lens system or have a focal length and an optical zooming capability.

The audio assembly 310 is configured to output and/or input an audio signal. For example, the audio assembly 310 includes a microphone (MIC). When the client 300 is in the operating mode, such as a call mode, a record mode, and a speech recognition mode, the microphone is configured to receive an external audio signal. The received audio signal may be further stored in the memory 304 or transmitted through the communications assembly 316. In some embodiments, the audio assembly 310 further includes a speaker, configured to output an audio signal.

The I/O interface provides an interface between the processing assembly 302 and an external interface module. The external interface module may be a keyboard, a click wheel, buttons, or the like. The buttons may include, but not limited to: a homepage button, a volume button, a start-up button, and a locking button.

The sensor assembly 314 includes one or more sensors, configured to provide state evaluation in each aspect to the client 300. For example, the sensor assembly 314 may detect a powered-on/off state of the client 300 and relative positioning of components. For example, the components are a display and a keypad of the client 300. The sensor assembly 314 may further detect changes in a location of the client 300 or a component of the client 300, a touch between the user and the client 300, an azimuth or acceleration/deceleration of the client 300 and changes in a temperature of the client 300. The sensor assembly 314 may include a proximity sensor, configured to detect the existence of nearby objects without any physical contact. The sensor assembly 314 may further include an optical sensor, such as a CMOS or CCD image sensor, that is used in an imaging application. In some embodiments, the sensor assembly 314 may further include an acceleration sensor, a gyroscope sensor, a magnetic sensor, a pressure sensor, or a temperature sensor.

The communications assembly 316 is configured to facilitate communication in a wired or wireless manner between the client 300 and other devices. The client 300 may access a communications standard-based wireless network, such as WiFi, 2G, or 3G, or a combination thereof. In an exemplary embodiment, the communications assembly 316 receives a broadcast signal or broadcast related information from an external broadcast management system through a broadcast channel. In an exemplary embodiment, the communication assembly 316 further includes a near field communication (NFC) module, to promote short range communication. For example, the NFC module may be implemented based on a radio frequency identification (RFID) technology, an infra-red data association (IrDA) technology, an ultra wideband (UWB) technology, a Bluetooth (BT) technology, and other technologies.

In an exemplary embodiment, the client 300 can be implemented as one or more application specific integrated circuit (ASIC), a digital signal processor (DSP), a digital signal processing device (DSPD), a programmable logic device (PLD), a field programmable gate array (FPGA), a controller, a micro-controller, a microprocessor or other electronic element, so as to perform the following method:

acquiring a search keyword;

determining a plurality of target keywords related to the search keyword; and

displaying the search keyword and the plurality of target keywords, the plurality of target keywords being distributed on a periphery of a circle with the search keyword as a center in a dispersed manner.

In an implementation, the displaying the search keyword and the plurality of target keywords includes:

displaying the search keyword and the plurality of target keywords in a form of a compass, the search keyword being located at a center of the compass, and the plurality of target keywords being distributed on a periphery of the compass.

In an implementation, the plurality of target keywords include a first keyword, and the method further includes:

acquiring a content matching the first keyword and the search keyword; and

displaying a knowledge card corresponding to the first keyword, the knowledge card corresponding to the first keyword including the content matching the first keyword and the search keyword.

In an implementation, the method further includes:

displaying an association between the first keyword and the search keyword.

In an implementation, the first keyword is in a selected state.

In an implementation, the method further includes:

acquiring a second keyword in the plurality of target keywords in response to a target keyword switching operation triggered by a user;

acquiring a content matching the second keyword and the search keyword; and

replacing the knowledge card corresponding to the first keyword with a knowledge card corresponding to the second keyword for display, the knowledge card corresponding to the second keyword including the content matching the second keyword and the search keyword.

In an implementation, the target keyword switching operation includes:

a click operation or a slide operation.

In an implementation, the method further includes:

modifying a state of the second keyword to the selected state, and modifying a state of the first keyword to an unselected state.

In an implementation, the method further includes:

acquiring a content matching a third keyword in the plurality of target keywords and the search keyword in response to a knowledge card switching operation triggered by a user; and

replacing the knowledge card corresponding to the first keyword with a knowledge card corresponding to the third keyword for display, the knowledge card corresponding to the third keyword including the content matching the third keyword and the search keyword.

In an implementation, the method further includes:

modifying a state of the third keyword to the selected state, and modifying a state of the first keyword to an unselected state.

In an implementation, the method further includes:

acquiring search results corresponding to the search keyword; and

displaying the search results in a search result display region; and

the displaying the search keyword and the plurality of target keywords includes:

displaying the search keyword and the plurality of target keywords in a content recommendation region.

In an implementation, the plurality of target keywords include a first keyword, and the method further includes:

acquiring a search result item matching the first keyword in the search results;

and

displaying an association between the search result item matching the first keyword in the search results and the first keyword.

In an implementation, the determining a plurality of target keywords related to the search keyword includes:

determining a plurality of contents related to the search keyword;

determining a keyword corresponding to each of the plurality of contents;

sorting the keywords respectively corresponding to the plurality of contents according to degrees of relevance to the search keyword and/or degrees of popularity of the keywords; and

determining a preset quantity of keywords ranked top as the plurality of target keywords.

In an implementation, the plurality of contents include a first content, and the determining a keyword corresponding to the first content includes:

determining, when a graph entity library includes the first content, a graph entity corresponding to the first content in the graph entity library as the keyword corresponding to the first content,

the graph entity library including at least a correspondence between a graph entity and a content corresponding to the graph entity.

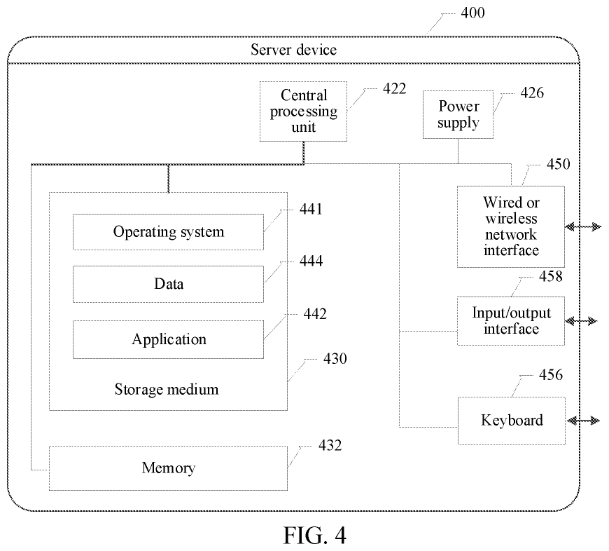

FIG. 4 is a schematic structural diagram of a server according to an embodiment of this application. The server 400 may vary greatly due different configurations or performance, and may include one or more central processing units (CPU) 422 (for example, one or more processors) and memories 432, and one or more storage media 430 (for example, one or more mass storage devices) storing an application 442 or data 444. The memory 432 and the storage mediums 430 may be used for transient storage or permanent storage. A program stored in the storage medium 430 may include one or more modules (which are not marked in the figure), and each module may include a series of instruction operations on the server. Further, the CPU 422 may be set to communicate with the storage medium 430, and perform, on the server 400, the series of instruction operations in the storage medium 430.

Further, the CPU 422 may perform the following method:

acquiring a search keyword;

determining a plurality of target keywords related to the search keyword; and

displaying the search keyword and the plurality of target keywords, the plurality of target keywords being distributed on a periphery of a circle with the search keyword as a center in a dispersed manner.

In an implementation, the displaying the search keyword and the plurality of target keywords includes:

displaying the search keyword and the plurality of target keywords in a form of a compass, the search keyword being located at a center of the compass, and the plurality of target keywords being distributed on a periphery of the compass.

In an implementation, the plurality of target keywords include a first keyword, and the method further includes:

acquiring a content matching the first keyword and the search keyword; and

displaying a knowledge card corresponding to the first keyword, the knowledge card corresponding to the first keyword including the content matching the first keyword and the search keyword.

In an implementation, the method further includes:

displaying an association between the first keyword and the search keyword.

In an implementation, the first keyword is in a selected state.

In an implementation, the method further includes:

acquiring a second keyword in the plurality of target keywords in response to a target keyword switching operation triggered by a user;

acquiring a content matching the second keyword and the search keyword; and

replacing the knowledge card corresponding to the first keyword with a knowledge card corresponding to the second keyword for display, the knowledge card corresponding to the second keyword including the content matching the second keyword and the search keyword.

In an implementation, the target keyword switching operation includes:

a click operation or a slide operation.

In an implementation, the method further includes:

modifying a state of the second keyword to the selected state, and modifying a state of the first keyword to an unselected state.

In an implementation, the method further includes:

acquiring a content matching a third keyword in the plurality of target keywords and the search keyword in response to a knowledge card switching operation triggered by a user; and

replacing the knowledge card corresponding to the first keyword with a knowledge card corresponding to the third keyword for display, the knowledge card corresponding to the third keyword including the content matching the third keyword and the search keyword.

In an implementation, the method further includes:

modifying a state of the third keyword to the selected state, and modifying a state of the first keyword to an unselected state.

In an implementation, the method further includes:

acquiring search results corresponding to the search keyword; and

displaying the search results in a search result display region; and

the displaying the search keyword and the plurality of target keywords includes:

displaying the search keyword and the plurality of target keywords in a content recommendation region.

In an implementation, the plurality of target keywords include a first keyword, and the method further includes:

acquiring a search result item matching the first keyword in the search results;

and

displaying an association between the search result item matching the first keyword in the search results and the first keyword.

In an implementation, the determining a plurality of target keywords related to the search keyword includes:

determining a plurality of contents related to the search keyword;

determining a keyword corresponding to each of the plurality of contents;

sorting the keywords respectively corresponding to the plurality of contents according to degrees of relevance to the search keyword and/or degrees of popularity of the keywords; and

determining a preset quantity of keywords ranked top as the plurality of target keywords.

In an implementation, the plurality of contents include a first content, and the determining a keyword corresponding to the first content includes:

determining, when a graph entity library includes the first content, a graph entity corresponding to the first content in the graph entity library as the keyword corresponding to the first content,

the graph entity library including at least a correspondence between a graph entity and a content corresponding to the graph entity.

The server 400 may further include one or more power supplies 426, one or more wired or wireless network interfaces 450, one or more input/output interfaces 456, one or more keyboards 456, and/or, one or more operating systems 441, for example, Windows Server™, Mac OS X™, Unix™, Linux™, and FreeBSD™.

The embodiments of this application further provide a non-transitory computer-readable medium, storing instructions, the instructions, when executed by one or more processors, causing an apparatus to perform the data processing method provided in the foregoing method embodiments.

After considering the specification and practicing the present disclosure, a person skilled in the art may easily conceive of other implementations of this application. This application is intended to cover any variations, uses, or adaptive changes of this application following the general principles of this application, and includes well-known knowledge and conventional technical means in the art and undisclosed in the present disclosure. The specification and the embodiments are considered as merely exemplary, and the scope and spirit of this application are pointed out in the following claims.

In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit. It is to be understood that this application is not limited to the precise structures described above and shown in the accompanying drawings, and various modifications and changes can be made without departing from the scope of this application. The scope of this application is subject only to the appended claims.

The foregoing descriptions are merely exemplary embodiments of this application, but are not intended to limit this application. Any modification, equivalent replacement, or improvement made without departing from the spirit and principle of this application shall fall within the protection scope of this application.

What is claimed is:

1. A data processing method performed at a computing device, the method comprising:
acquiring a search keyword;
determining a plurality of target keywords related to the search keyword; and
causing a display of the search keyword and the plurality of target keywords on a display, the plurality of target keywords being distributed on a periphery of a circle with the search keyword as a center in a dispersed manner.

2. The method according to claim 1, wherein the causing a display of the search keyword and the plurality of target keywords comprises:
causing a display of the search keyword and the plurality of target keywords in a form of a compass, the search keyword being located at a center of the compass, and the plurality of target keywords being distributed on a periphery of the compass.

3. The method according to claim 1, wherein the plurality of target keywords comprise a first keyword, and the method further comprises:
acquiring a content matching the first keyword and the search keyword; and
causing a display of a knowledge card corresponding to the first keyword, the knowledge card corresponding to the first keyword comprising the content matching the first keyword and the search keyword.

4. The method according to claim 3, further comprising:
causing a display of an association between the first keyword and the search keyword.

5. The method according to claim 3, wherein the first keyword is in a selected state.

6. The method according to claim 3, further comprising:
acquiring a second keyword in the plurality of target keywords in response to a target keyword switching operation triggered by a user;
acquiring a content matching the second keyword and the search keyword; and
replacing the knowledge card corresponding to the first keyword with a knowledge card corresponding to the second keyword for display, the knowledge card corresponding to the second keyword comprising the content matching the second keyword and the search keyword.

7. The method according to claim 3, further comprising:
acquiring a content matching a third keyword in the plurality of target keywords and the search keyword in response to a knowledge card switching operation triggered by a user; and
replacing the knowledge card corresponding to the first keyword with a knowledge card corresponding to the third keyword for display, the knowledge card corresponding to the third keyword comprising the content matching the third keyword and the search keyword.

8. The method according to claim 1, further comprising:
acquiring search results corresponding to the search keyword; and
causing a display of the search results in a search result display region; and
the causing a display of the search keyword and the plurality of target keywords comprising:
causing a display of the search keyword and the plurality of target keywords in a content recommendation region.

9. The method according to claim 8, wherein the plurality of target keywords comprise a first keyword, and the method further comprises:
acquiring a search result item matching the first keyword in the search results; and
causing a display of an association between the search result item matching the first keyword in the search results and the first keyword.

10. The method according to claim 1, wherein the determining a plurality of target keywords related to the search keyword comprises:
determining a plurality of contents related to the search keyword;
determining a keyword corresponding to each of the plurality of contents;
sorting the keywords respectively corresponding to the plurality of contents according to their respective degrees of relevance to the search keyword and/or degrees of popularity of the keywords; and
determining a preset quantity of keywords ranked top as the plurality of target keywords.

11. The method according to claim 10, wherein the plurality of contents comprise a first content, and the determining a keyword corresponding to the first content comprises:
determining, when a graph entity library comprises the first content, a graph entity corresponding to the first content in the graph entity library as the keyword corresponding to the first content,
the graph entity library comprising at least a correspondence between a graph entity and a content corresponding to the graph entity.

12. A computing device, comprising a processor and a memory, the memory storing instructions that, when executed by the processor, cause the computing device to perform a data processing method including:
acquiring a search keyword;
determining a plurality of target keywords related to the search keyword; and
causing a display of the search keyword and the plurality of target keywords on a display, the plurality of target keywords being distributed on a periphery of a circle with the search keyword as a center in a dispersed manner.

13. The computing device according to claim 12, wherein the causing a display of the search keyword and the plurality of target keywords comprises:
causing a display of the search keyword and the plurality of target keywords in a form of a compass, the search keyword being located at a center of the compass, and the plurality of target keywords being distributed on a periphery of the compass.

14. The computing device according to claim 12, wherein the plurality of target keywords comprise a first keyword, and the method further comprises:
acquiring a content matching the first keyword and the search keyword; and
causing a display of a knowledge card corresponding to the first keyword, the knowledge card corresponding to the first keyword comprising the content matching the first keyword and the search keyword.

15. The computing device according to claim 14, wherein the data processing method further comprises:
acquiring a second keyword in the plurality of target keywords in response to a target keyword switching operation triggered by a user;
acquiring a content matching the second keyword and the search keyword; and
replacing the knowledge card corresponding to the first keyword with a knowledge card corresponding to the second keyword for display, the knowledge card corresponding to the second keyword comprising the content matching the second keyword and the search keyword.

16. The computing device according to claim 12, wherein the data processing method further comprises:
acquiring search results corresponding to the search keyword; and
causing a display of the search results in a search result display region; and
the causing a display of the search keyword and the plurality of target keywords comprising:
causing a display of the search keyword and the plurality of target keywords in a content recommendation region.

17. The computing device according to claim 16, wherein the plurality of target keywords comprise a first keyword, and the data processing method further comprises:
acquiring a search result item matching the first keyword in the search results; and
causing a display of an association between the search result item matching the first keyword in the search results and the first keyword.

18. The computing device according to claim 12, wherein the determining a plurality of target keywords related to the search keyword comprises:
determining a plurality of contents related to the search keyword;
determining a keyword corresponding to each of the plurality of contents;
sorting the keywords respectively corresponding to the plurality of contents according to their respective degrees of relevance to the search keyword and/or degrees of popularity of the keywords; and
determining a preset quantity of keywords ranked top as the plurality of target keywords.

19. The computing device according to claim 18, wherein the plurality of contents comprise a first content, and the determining a keyword corresponding to the first content comprises:
determining, when a graph entity library comprises the first content, a graph entity corresponding to the first content in the graph entity library as the keyword corresponding to the first content,
the graph entity library comprising at least a correspondence between a graph entity and a content corresponding to the graph entity.

20. A non-transitory computer-readable storage medium, comprising instructions that, when executed by a processor of a computing device, cause the computing device to perform a data processing method including:
acquiring a search keyword;
determining a plurality of target keywords related to the search keyword; and
causing a display of the search keyword and the plurality of target keywords on a display, the plurality of target keywords being distributed on a periphery of a circle with the search keyword as a center in a dispersed manner.
